(19) United States
(12) Patent Application Publication
(10) Pub. No.: US 2024/0253959 A1
(43) Pub. Date: Aug. 1, 2024

(54) PORTABLE APPARATUS FOR MOVING A VEHICLE

(71) Applicant: HENRY LEE FORD, MONROE, GA (US)

(72) Inventor: HENRY LEE FORD, MONROE, GA (US)

(21) Appl. No.: 18/406,466

(22) Filed: Jan. 8, 2024

Related U.S. Application Data
(60) Provisional application No. 63/441,941, filed on Jan. 30, 2023.

(51) Int. Cl. B66F 3/44

(52) U.S. Cl. CPC B66F 3/44

(57) ABSTRACT

An apparatus for moving a broken-down vehicle. The apparatus can be coupled to a rear tow hitch on the vehicle to move the vehicle. The apparatus includes a frame and a tow bar coupled to the frame that can be attached to the tow hitch of the vehicle. A wheel is mounted to the frame. A motor mounted to the frame can drive the wheel. A jack mounted to the frame can increase and decrease the distance between the wheel and the tow bar. A control button can be used to turn the motor on and off, wherein the control button can be positioned within a cabin of the vehicle in proximity to the driver seat. The motor can be powered by a battery of the vehicle or a separate battery that is mounted to the frame.

### CROSS-REFERENCE TO RELATED APPLICATIONS

This application claims priority from a U.S. Provisional Patent Appl. No. 63/441,941, filed on Jan. 30, 2023, the disclosure of which is incorporated herein by reference in its entirety.

### FIELD OF INVENTION

The present invention relates to an apparatus for moving a vehicle, and more particularly, the present invention relates to a portable apparatus for moving a broken-down vehicle.

### BACKGROUND

Automobiles have become a crucial part of daily life that allows people to travel to different places easily and conveniently. Privately owned Lightweight four-wheel vehicles, such as cars are widely used for commuting needs. People like to own a private automobile so to reach a destination safely and easily. Also, private automobiles are used to transport loads, packages, and the like.

Automobiles, like any machine, are susceptible to breakdown due to a variety of reasons. For example, it is common for a car to stop working in the middle of a road. Or the car may not start due to any reason and requires professional assistance for repairs. Whatever the reasons for automobile failure may be, the broken-down automobile needs to be pushed to a nearby mechanic or service center. Typically, cranes are used to tow a broken-down automobile to a service center or any other location. However, cranes may not be available to a user all the time or everywhere. Also, the services of a crane are costly and not preferable for short distances. Thus, based on the situation, a user may have to manually push the broken-down automobile. In the case of a four-wheel automobile, manual pushing the automobile can be very laborious and painstaking. Moreover, it is difficult for a single person to both control and push the vehicle at the same time.

A need is therefore appreciated for an apparatus that may help move a broken-down vehicle.

The vehicle herein includes automobiles, preferably the lightweight passenger and commercial vehicles having three or more wheels, and includes cars, lightweight trucks, sports utility vehicles, and the like. The vehicle has a tow hitch on its rear side.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to an apparatus for moving a broken-down vehicle.

Another object of the present invention is that the apparatus is portable.

Still, another object of the present invention is that the apparatus can be operated from the cabin of a vehicle.

Yet another object of the present invention is that the apparatus is compact and foldable.

In one aspect, disclosed is an apparatus for moving a vehicle, the apparatus comprises a frame; a tow bar coupled to the frame and configured to couple to an attachment point in the vehicle; a wheel mounted to the frame; a jack for increasing and decreasing a distance between the wheel and the tow bar, the jack mounted to the frame; and a motor for driving the wheel, the motor mounted to the frame. The attachment point is a tow hitch on rear side of the vehicle. The apparatus further comprises a battery mounted to the frame, the battery configured to power the motor. The apparatus further comprises a control button configured to be positioned within a cabin of the vehicle, wherein control button is configured to turn the motor on and off. A wire couples the control button and the motor.

In one aspect, disclosed is a method for moving a vehicle, the method comprises providing an apparatus. The apparatus comprising a frame, a tow bar coupled to the frame and configured to couple to a tow hitch on a rear side of the vehicle, a wheel mounted to the frame, a jack for increasing and decreasing a distance between the wheel and the tow bar, the jack mounted to the frame, and a motor for driving the wheel, the motor mounted to the frame. The method further comprises coupling the apparatus to the vehicle through the tow hitch and the tow bar; and upon coupling, operating the jack to increase the distance between the wheel and the tow bar so that at least some weight of the vehicle is taken by the apparatus. The apparatus further comprises a battery mounted to the frame, the battery configured to power the motor. The apparatus further comprises a control button configured to be positioned within a cabin of the vehicle, wherein the control button is configured to turn the motor on and off. The method further comprises turning on, by a driver sitting in the driver seat, the control button. A wire couples the control button and the motor.

### BRIEF DESCRIPTION OF DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a block diagram showing an implementation of the apparatus, according to an exemplary embodiment of the present invention.

FIG. 2 is a block diagram showing an implementation of the apparatus, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting to embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

Disclosed is an apparatus for moving a vehicle on the ground. The disclosed apparatus is separate from the vehicle and can be fitted to the vehicle as and when required. The disclosed apparatus can help move a broken-down vehicle. For example, the vehicle not starting can be moved by the disclosed apparatus to a nearby place. The nearby place can be a parking, a service station, a side-of-road, and the like suitable place. The disclosed apparatus saves the driver and/or passengers of the vehicle from manually pushing the broken-down vehicle. Moreover, the apparatus can be portable and can be easily carried to the broken-down vehicle. Also, the apparatus can be carried within the vehicle. The apparatus may also be of a compact profile that allows storing the apparatus economical and convenient. Moreover, the apparatus can be foldable to be compact in construction, wherein the apparatus can be folded for storage.

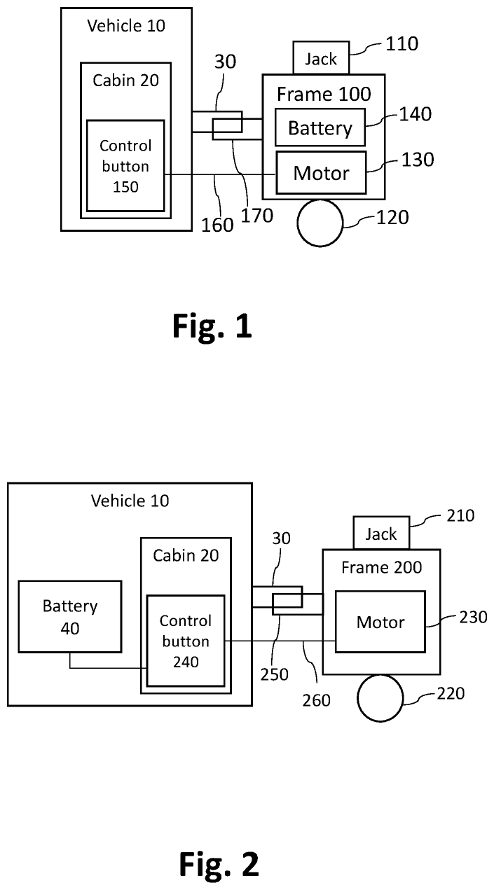

Referring to FIG. 1 is a block diagram showing an implementation of the disclosed apparatus. FIG. 1 shows vehicle 10, which can be a car. The vehicle has cabin 20 which includes a driver seat. The vehicle also includes a tow hitch 30 on the rear side of the vehicle.

The apparatus includes a frame 100, a jack 110, a wheel 120, a motor 130, a battery 140, a control button 150, a wire 160, and a tow bar 170.

The frame can be made from metal or similar durable material for strength and durability. The wheel can be mounted to the bottom of the frame. The wheel can rotate relative to the frame. Suitable bearing and like can be used to reduce friction between the wheel and the frame. The size of the wheel can be varied and may depend on the capacity of the apparatus to push a vehicle. It is to be noted that wheels of all sizes are within the scope of the present invention. For example, the wheel can be of about 12-inch, 13-inch, . . . and 20-inch like rims. The wheel size may also correspond to the size of the vehicle to be pushed by the apparatus. However, the wheel of the apparatus can be different from the wheel of the vehicle in construction and size. The wheel can be made from metal or suitable material, such that is strong and durable. Preferably lightweight material for the frame and wheel can be used that is strong and durable. Lightweight material may allow the apparatus to be lightweight.

The wheel may have a suitable tire of increased traction with the ground so as to push the vehicle. It may be preferable that the tire can have higher traction than normal wheels so that the vehicle can be pushed. Traction wheels can also be used for enhanced traction. Also, it is to be noted that one wheel may be preferable, however, the use of two wheels in the disclosed apparatus is within the scope of the present invention. The two wheels can provide more stability to the apparatus but become less portable. The two wheels can be rotatably mounted to the frame. Also, the two wheels can be connected through a shaft and the shaft, and the setup can be mounted to the frame. This may allow both the wheels to rotate simultaneously.

The motor can be mounted to the frame and operably coupled to the wheel. The motor can be used to turn the wheels to move the vehicle. The motor can be powered by the battery. The battery can also be mounted to the frame. The motor can be of suitable capacity that may allow the apparatus to move the vehicle. Also, the battery capacity can be optimized for driving the apparatus and moving the vehicle to a suitable distance. Also, it is to be noted that both the motor and the battery may not be so heavy that handling the apparatus by a person may become difficult. The battery can preferably be a rechargeable battery such as a lithium-ion battery that has high charge density. However, batteries of any type including rechargeable and disposable batteries are within the scope of the present invention. Also, more than one motor is within the scope of the present invention.

The tow bar can be used to couple the apparatus to the tow hitch of the vehicle. The tow bar can include a suitable fastening mechanism that allows the apparatus to be stably coupled to the vehicle. The tow bar and the fastening mechanism may prevent the apparatus from bending while the vehicle is moved by the apparatus. Also, it is to be understood that the drawing shows only one tow bar, however, more than one tow bar is within the scope of the present invention. More than one tow bar can be coupled to more than one attachment point in the vehicle. Also, the apparatus may couple to an attachment point other than the tow hitch on the vehicle, and any such attachment is within the scope of the present invention.

The jack of the apparatus can be mounted to the frame. Preferably, the frame may have a wheel portion and a main portion, the wheel can be mounted to the wheel portion and the tow bar can be coupled to the main frame. The jack may connect the main frame to the wheel frame. It is to be understood that any other supportive structure can couple the wheel frame to the main frame for stability of the wheel frame relative to the main frame. The jack may allow increasing and decreasing the distance between the wheel frame and the main frame. Preferably, the jack may allow increasing and decreasing the distance between the wheel and the tow bar. The jack may be mechanical, hydraulic, or electric. In the case of an electric jack, the jack can be powered by the battery of the disclosed apparatus. In the case of a mechanical jack, a handle can be provided to turn the jack.

In another implementation, the frame can include a tow bar frame and a main frame, wherein the jack is configured to increase and decrease the height of the tow bar relative to the ground.

The apparatus may also include a control button to turn on and off the motor. Such a control button can be positioned within the cabin of the vehicle and reach of a driver sitting in the driver seat of the vehicle. A wire can connect the control button to the motor.

In use, the apparatus can be mounted to the tow hitch of the vehicle that may have broken down for any reason. Once the tow bar is coupled to the tow hitch, the jack can be operated so that at least some weight of the vehicle is taken on the wheel of the disclosed apparatus i.e., the distance between the tow bar and the wheel is increased. This may allow suitable traction between the wheel of the disclosed apparatus and the road. Once the apparatus is deployed and the weight taken on the apparatus, the driver in the driver seat can turn on the motor of the apparatus using the control button. The vehicle may be kept neutral to allow the apparatus to move the vehicle. When the vehicle needs to be stopped, the control button can be used to turn off the motor. Thus, a driver sitting in the vehicle can operate the disclosed apparatus comfortably and easily. Additionally, the control button can be operably coupled to the brakes of the vehicles, such that upon pressing the brakes of the vehicle, the control button is automatically actuated to turn off the motor.

Referring to FIG. 2 shows another implementation of the disclosed apparatus in which the battery of the vehicle can be used to drive the disclosed apparatus. The apparatus includes a frame 200, a jack 210, a wheel 220, a motor 230, a control button 240, a wire 260, and a tow bar 250.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. An apparatus for moving a vehicle, the apparatus comprises:
a frame;
a tow bar coupled to the frame and configured to couple to an attachment point in the vehicle;
a wheel mounted to the frame;
a jack for increasing and decreasing a distance between the wheel and the tow bar, the jack mounted to the frame; and
a motor for driving the wheel, the motor mounted to the frame.

2. The apparatus of claim 1, wherein the attachment point is a tow hitch on rear side of the vehicle.

3. The apparatus of claim 1, wherein the apparatus further comprises a battery mounted to the frame, the battery configured to power the motor.

4. The apparatus of claim 1, wherein the apparatus further comprises a control button configured to be positioned within a cabin of the vehicle, wherein control button is configured to turn the motor on and off.

5. The apparatus of claim 4, wherein a wire couples the control button and the motor.

6. A method for moving a vehicle, the method comprises:
providing an apparatus comprising:
a frame,
a tow bar coupled to the frame and configured to couple to a tow hitch on a rear side of the vehicle,
a wheel mounted to the frame,
a jack for increasing and decreasing a distance between the wheel and the tow bar, the jack mounted to the frame, and
a motor for driving the wheel, the motor mounted to the frame;
coupling the apparatus to the vehicle through the tow hitch and the tow bar; and
upon coupling, operating the jack to increase the distance between the wheel and the tow bar so that at least some weight of the vehicle is taken by the apparatus.

7. The method of claim 6, wherein the apparatus further comprises a battery mounted to the frame, the battery configured to power the motor.

8. The method of claim 6, wherein the apparatus further comprises a control button configured to be positioned within a cabin of the vehicle, wherein the control button is configured to turn the motor on and off, wherein the method further comprises:
turning on, by a driver sitting in a driver seat, the control button.

9. The method of claim 8, wherein a wire couples the control button and the motor.
